(19) United States
(12) Patent Application Publication
(10) Pub. No.: US 2014/0362858 A1
(43) Pub. Date: Dec. 11, 2014

(54) Efficient Management of Linked-Lists Traversed by Multiple Processes

(71) Applicant: Broadcom Corporation, Irvine, CA (US)

(72) Inventors: Puneet Agarwal, Cupertino, CA (US); Meg Pei Lin, Saratoga, CA (US); Rupa Budhia, San Jose, CA (US)

(73) Assignee: Broadcom Corporation, Irvine, CA (US)

(21) Appl. No.: 14/025,175

(22) Filed: Sep. 12, 2013

Related U.S. Application Data
(60) Provisional application No. 61/831,240, filed on Jun. 5, 2013.

(51) Int. Cl. H04L 12/741

(52) U.S. Cl. CPC H04L 45/745
USPC 370/392

(57) ABSTRACT

A network device, such as a switch, implements enhanced linked-list processing features. The processing features facilitate packet manipulation actions performed, e.g., by hardware or software processes. Hardware processes may run for egress ports, for example, to traverse the linked-lists to apply the packet manipulation actions on packets before sending packets out of the ports.

### PRIORITY CLAIM

This application claims the priority benefit of U.S. Provisional Application Ser. No. 61/831,240, filed Jun. 5, 2013.

### TECHNICAL FIELD

This disclosure relates to linked-lists. This disclosure also relates to processing linked-lists in network devices such as switches.

### BACKGROUND

High speed data networks form part of the backbone of what has become indispensable worldwide data connectivity. Within the data networks, network devices such as switching devices direct data packets from source ports to destination ports, helping to eventually guide the data packets from a source to a destination. Improvements in network devices, including improvements in packet handling, will further enhance the performance of data networks.

### BRIEF DESCRIPTION OF THE DRAWINGS

FIG. 1 shows an example switch architecture that may implement linked-list processing.

FIG. 2 is an example linked-list management and processing architecture.

FIG. 3 is an example of a linked-list.

FIG. 4 illustrates processing logic that may be implemented by a linked-list processor.

FIG. 5 illustrates management logic that may be implemented by a linked-list manager.

### DETAILED DESCRIPTION

### Example Architecture

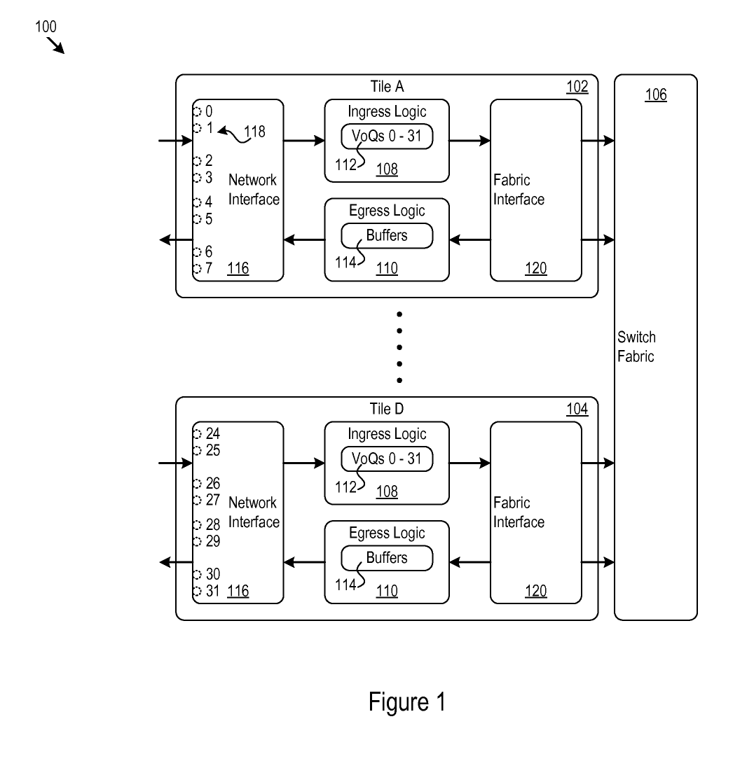

FIG. 1 shows an example of a switch architecture 100 that may include enhanced linked-list processing functionality. The description below provides a backdrop and a context for the explanation of linked-list processing, which follows this example architecture description. The linked-list processing described below may be performed in many different devices, including network devices, in many different ways. Accordingly, the example switch architecture 100 is presented as just one of many possible device architectures that may include enhanced linked-list processing functionality, and the example provided in FIG. 1 is just one of many different possible alternatives. The techniques described further below are not limited to any specific device architecture.

The switch architecture 100 includes several tiles, such as the tiles specifically labeled as tile A 102 and the tile D 104. In this example, each tile has processing logic for handling packet ingress and processing logic for handling packet egress. A switch fabric 106 connects the tiles. Packets, sent for example by source network devices such as application servers, arrive at the network interfaces 116. The network interfaces 116 may include any number of physical ports 118. The ingress logic 108 buffers the packets in memory buffers. Under control of the switch architecture 100, the packets flow from an ingress tile, through the fabric interface 120 through the switching fabric 106, to an egress tile, and into egress buffers in the receiving tile. The egress logic sends the packets out of specific ports toward their ultimate destination network device, such as a destination application server.

Each ingress tile and egress tile may be implemented as a unit (e.g., on a single die or system on a chip), as opposed to physically separate units. Each tile may handle multiple ports, any of which may be configured to be input only, output only, or bi-directional. Thus, each tile may be locally responsible for the reception, queueing, processing, and transmission of packets received and sent over the ports associated with that tile.

As an example, in FIG. 1 the tile A 102 includes 8 ports labeled 0 through 7, and the tile D 104 includes 8 ports labeled 24 through 31. Each port may provide a physical interface to other networks or network devices, such as through a physical network cable (e.g., an Ethernet cable). Furthermore, each port may have its own line rate (i.e., the rate at which packets are received and/or sent on the physical interface). For example, the line rates may be 10 Mbps, 100 Mbps, 1 Gbps, or any other line rate.

The techniques described below are not limited to any particular configuration of line rate, number of ports, or number of tiles, nor to any particular network device architecture. Instead, the techniques described below are applicable to any network device that incorporates the analysis logic described below. The network devices may be switches, routers, bridges, blades, hubs, or any other network device that handles delivery of packets from sources to destinations through a network. The network devices may be part of one or more networks that connect, for example, application servers together across the networks. The network devices may be present in one or more data centers that are responsible for routing packets from a source to a destination.

The tiles include packet processing logic, which may include ingress logic 108, egress logic 110, and any other logic in support of the functions of the network device. The ingress logic 108 processes incoming packets, including buffering the incoming packets by storing the packets in memory. The ingress logic 108 may define, for example, virtual output queues 112 (VoQs), by which the ingress logic 108 maintains one or more queues linking packets in memory for the egress ports. The ingress logic 108 maps incoming packets from input ports to output ports, and determines the VoQ to be used for linking the incoming packet in memory. The mapping may include, as examples, analyzing addressee information in the packet headers, and performing a lookup in a mapping table that matches addressee information to output port(s).

The egress logic 110 may maintain one or more output buffers 114 for one or more of the ports in its tile. The egress logic 110 may implement hardware processes (e.g., in state machines) that process linked-lists. For example, the egress logic 110 may implement one or more linked-list processors (LLPs) for each egress port. The LLP processing may, as one example, result in packet replication and delivery through a particular egress port to any connected device according to the processing specified by each entry in the linked-list.

### Linked-List Processing and Management

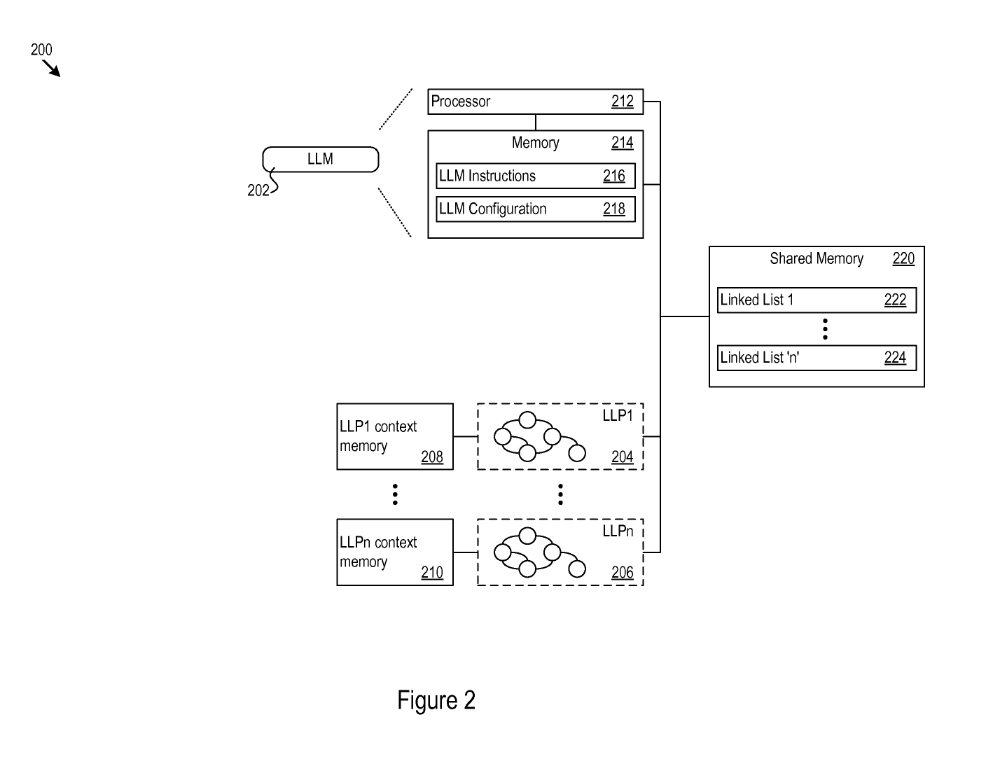

FIG. 2 is an example linked-list management and processing architecture 200 (“architecture 200”) that may be present in a device, such as the switch architecture 100. The architecture 200 includes a linked-list manager (LLM) 202, and multiple linked-list processors (LLP), e.g., the LLPs 204 and 206. The architecture 200 may include one or more LLPs for each egress port, for example. The LLPs may be implemented as hardware state machines, as one example. However, any of the LLPs or LLM may be implemented in any desired combination of hardware and software. Each LLP may have access to a local context memory, e.g., the context memories 208 and 210 for the LLPs 204 and 206. Among other things, the context memories may store linked-list processing information as described below.

The LLM 202 functionality may be implemented in software. To that end, the LLM 202 implementation may include a processor 212 and a memory 214 that stores LLM instructions 216 and LLM configuration information 218. The LLM instructions 216 implement linked-list management as described below, for example to insert and delete entries from linked-lists. The LLM 202 also maintains tracking indicia that help the LLPs ensure that they are not acting on linked-list elements that are no longer part of their linked-list.

The LLM configuration information 218 may specify configurable parameters for the LLM instructions 216. Examples of LLM configuration information 218 data include counter values (e.g., for obtaining new tracking values), specifiers of alternate tracking value generators, the size of the memory pool from which linked-list entries are created, the location of the linked-lists in the shared memory 220, identifiers of linked-list entries already allocated and available for insertion into new linked-lists, and other parameters. The LLM configuration information 218 may store any other configuration data relevant to the execution of the LLM 202.

The LLM 202 and the LLPs have access to a shared memory 220. The shared memory 220 may store linked-lists, e.g., the linked-lists 222 and 224. There may be any number of linked-lists and they may be of any length.

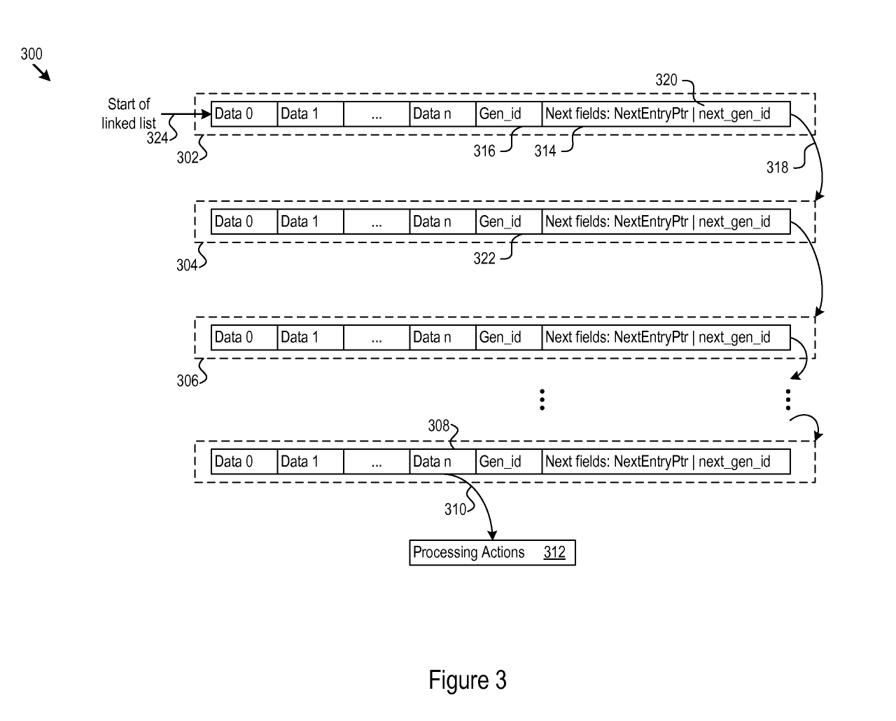

FIG. 3 shows an example of a linked-list 300. The linked-list 300 includes multiple entries, such as the entries 302, 304, and 306. Each entry includes one or more data elements, e.g., the data element 308. The data elements may represent processing actions to be taken by an LLP traversing the linked-list. In some implementations, the data elements may be pointers 310 to processing actions 312 that specify what actions the LLP should take. In the context of a network switch, the data elements may be pointers to processing actions to be taken on network packets before the network packets are sent out an egress port. As one example, each entry in a linked list may represent a subscriber to a data flow, e.g., a series of MPEG packets encoding a video channel. Then, the LLP for an egress port may, for each packet: 1) read the head pointer 324 to find the start of the linked-list 2) traverse the linked-list and replicate the packet for each entry in the linked-list (and perform specific processing actions on the packet), send the replicated packet out the egress port, 3) and retrieve the next packet and repeat.

The LLPs begin reading at the head of a given linked-list. For each read, the LLP may extract a valid data element and perform processing according to the data element. After processing is done, the LLP may store current context in its context memory. The context may include: Address, the address of the shared memory to read from (e.g., the address of the current linked-list entry) the next time the LLP resumes; Index, the index to the data element within the linked-list entry to process. When the LLP processes the last data element within an entry, the LLP stores the next entry pointer as the Address in the context memory and 0 as the Index.

There may be one or more LLPs for each egress port, and as a result there may be at any given time multiple LLPs traversing any given linked-list. At the same time, the LLM 202 may be adding and removing entries from any of the linked-lists in the shared memory 220. As a result, the LLM 202 may take steps to change a particular linked-list at any time, and often while multiple LLPs are presently traversing the particular linked-list. In that respect, the LLM 202 runs asynchronously with respect to the LLPs. One concern is that the LLM 202 may delete, change, or reallocate any particular linked-list entry after an LLP has read the pointer to that entry. Accordingly, if the LLP follows the pointer, the LLP may try to process data no longer valid or appropriate. One approach to handling this difficulty is for the LLM 202 to leave the existing linked-list unchanged, make a shadow copy of the linked-lists that it needs to change, and point the LLPs to the shadow copies for subsequent traversals.

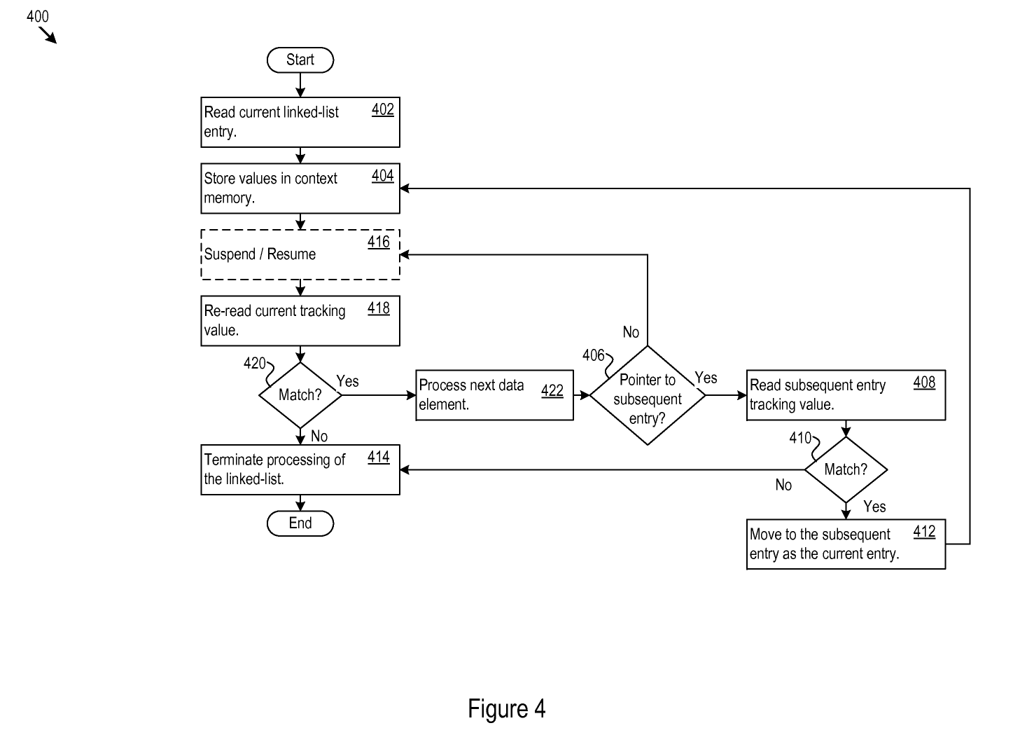

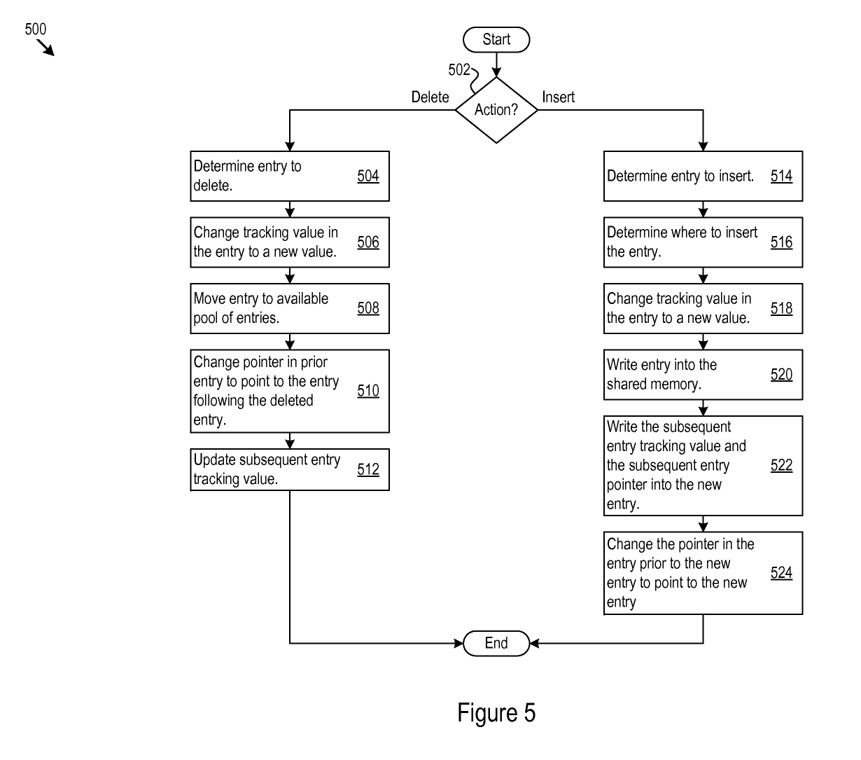

The technique described below facilitates changes to the linked-lists, in place. As a result, the LLM 202 need not make shadow copies of modified linked-lists for LLPs to process, while the LLM 202 waits for all LLPs to finish their processing of the current copy of the linked-list. A significant reduction in the amount of memory needed to store the linked-lists may result. Reference is made to FIGS. 4 and 5 for the discussion below, with FIG. 4 showing processing logic 400 that an LLP may implement, and FIG. 5 showing management logic 500 that an LLM 202 may implement.

Returning to the example in FIG. 3, each linked list entry includes next element fields 314 and a current entry tracking field 316 (labeled Gen_id in FIG. 3) for the current linked-list entry (e.g., entry 302). The next element fields 314 may include a next pointer to the subsequent entry, e.g., the next entry pointer 318. The next element fields 314 also include a subsequent entry tracking field 320 that stores the expected value of the tracking field in the subsequent entry (e.g., entry 304), e.g., the Gen_id value in the subsequent entry.

An LLP reads the current linked-list entry (402) for processing. The read may be an atomic read operation that obtains all of the data in the entry in one operation, for example. The LLP stores values relevant to the linked-list processing in its context memory (404). Examples of such values include the current tracking value specified in the current entry, the subsequent entry tracking value specified in the current entry, a pointer to the current entry the LLP is processing, and an offset or pointer to the specific data element that the LLP is working on in the current entry. That is, the LLP need not store the entire current entry in its context memory.

When an LLP has finished processing the current list entry and is ready to move on to the subsequent list entry for processing, the LLP reads the next pointer (406) in the current entry and reads the actual subsequent entry tracking value from the subsequent entry (408). The LLP then determines whether the tracking value in the subsequent entry tracking field 320 matches the tracking value actually present in the subsequent entry (e.g., the tracking value 322 in the entry 304) (410). If the tracking values match, then the LLP moves ahead to the subsequent entry, which becomes the current entry (412) that the LLP is processing (412). If the tracking values do not match, then the LLP stops processing the linked-list (414).

As previously noted, the context memory for each LLP may store information relevant to the processing of the linked-lists by the LLP. For example, the context memory may store the subsequent entry tracking value specified in the current entry, a pointer to the current entry the LLP is processing, and an offset or pointer to the specific data element that the LLP is working on in the current entry (e.g., rather than storing the entire entry in the context memory). When the LLP prepares to move to the subsequent entry, it compares the subsequent entry tracking value in the current entry to the actual value present in the subsequent entry, as noted above.

Expressed another way, the shared memory 220 may store a linked list that includes a current list entry (e.g., entry 302) and a subsequent list entry (e.g., 304). The current list entry includes a pointer to the subsequent list entry and a next tracking field configured to store a next tracking value expected in the subsequent list entry. The subsequent list entry includes a subsequent tracking field configured to store a subsequent tracking value for the subsequent list entry. Logic (e.g., an LLP) in communication with the shared memory 220 is configured to read the next tracking value, follow the pointer and read the subsequent tracking field from the subsequent list entry, and determine whether a match exists between the next tracking value the subsequent tracking value. The logic then determines whether to process the subsequent list entry according to whether the match exists.

Note also that the LLP may store the current tracking value in the context memory for the current entry that the LLP is processing, e.g., when the LLP first references the current entry (404). Accordingly, when the LLP stops and resumes processing the current entry (416), the LLP may re-read the current tracking value from the current linked-list entry (418) and check whether the current tracking value stored in its context memory is different from the tracking value that the LLP re-reads from the current entry (420). If the tracking values are different, then the LLP may assume that the LLM 202 has modified the entry, and may terminate processing the entry and the linked-list (414). This check will prevent he LLP from replicating packets to incorrect recipients.

Otherwise, the LLP processes the next data element (422). The next data element may specify actions to take on the current packet, for example. Once the actions are taken, the LLP send the packet out the egress port with which the LLP is associated.

In concert with the LLP processing, the LLM 202 is adding and deleting linked-list entries at any time (502). When the LLM 202 deletes an entry, or for any other reason decides to stop LLPs from processing an entry, the LLM 202 determines which entry to delete (504). The LLM 202 then changes the tracking value in the entry to delete (506). The LLM 202 may also move the entry to an available pool of entries from which the LLM 202 may obtain new entries for insertion into linked-lists (508).

In addition, the LLM 202 changes the pointer in the entry prior to the deleted entry to point to the entry that followed the entry that the LLM 202 deleted (510). Accordingly, the LLM 202 also updates the subsequent entry tracking value in the prior entry (512). In other words, the LLM 202 reconfigures the entry prior to the deleted entry to point to the entry following the deleted entry, including updating the prior entry with the tracking value stored in the following entry. The operations (514)-(524) may be performed with atomic write operations.

In this manner, the LLM 202 changes the tracking value whenever an entry is deleted to, e.g., be re-used as part of a different linked-list. When the subsequent tracking value in the current entry matches the tracking value actually present in the subsequent entry, the LLP knows the subsequent entry is still part of the current linked-list that the LLP is traversing. In that case, the LLP continues by processing the subsequent entry. Otherwise, if the actual tracking value is different, then the LLP understands that the LLM 202 has moved, deleted, modified, or made the subsequent entry part of a new linked-list. In that case, the LLP may terminate processing the linked-list.

To set the tracking value for a new entry added to a linked-list, the LLM 202 may take any of several different approaches. For example, the LLM 202 may start with a tracking value of zero, for a newly allocated entry. For entries that are re-used (e.g., deleted from an existing linked-list, modified, and inserted into a different linked-list), the LLM 202 may increment the current value of the tracking value in the entry to obtain a new tracking value. In other implementations, the LLM 202 may compute and save a hash value as the tracking value, may save a random value, may evaluate a linear feedback shift register (LFSR), or may increment a counter (e.g., an 8-bit or 16-it counter) to obtain a new value. In any event, the LLM 202 may modify (e.g., increment) the value if it happens to be identical to the existing value.

The LLM 202 may add entries to any linked-lists at any time. To insert the new entry, the LLM 202 determines which entry to insert (514), e.g., by re-using an existing entry or by allocating a new entry from a memory pool, and also determines where to insert the new entry (516). The insertion may happen at the head of a linked-list, at the end of the linked-list, or between the head and the end of the lined-list.

When the LLM 202 writes an entry and links it into a linked-list, the LLM 202 gives the new entry a new tracking value (518) and writes the new entry into the shared memory 220 (520). The LLM 202 also writes the subsequent entry tracking value and the subsequent entry pointer into the new entry (522). That is, the new entry is setup with its own new tracking value, subsequent entry pointer, and tracking value for the subsequent entry. The subsequent entry is, e.g., the next entry in the linked-list that will follow the new entry once the new entry is inserted into the linked-list. To complete the insertion, the LLM 202 changes the next entry pointer in the entry prior to the new entry to point to the new entry (524). Of course, if the new entry is at the head of the linked-list, there is no prior entry pointer to change.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system comprising:
a memory configured to store:
a linked list comprising a current list entry and a subsequent list entry;
the current list entry comprising:
a pointer to the subsequent list entry; and
a next tracking field configured to store a next tracking value expected in the subsequent list entry;
the subsequent list entry comprising:
a subsequent tracking field configured to store a subsequent tracking value for the subsequent list entry; and
processing logic in communication with the memory, the processing logic configured to:
read the next tracking value;
follow the pointer and read the subsequent tracking field;
determine whether a match exists between the next tracking value the subsequent tracking value; and
determine whether to process the subsequent list entry according to whether the match exists.

2. The system of claim 1, further comprising:
management logic in communication with the memory, the management logic configured to:
determine to delete the subsequent list entry; and
in response to determining to delete the subsequent list entry, change the subsequent list entry value to a different value.

3. The system of claim 2, where the management logic is configured to change the subsequent list entry value by incrementing the value.

4. The system of claim 2, where the management logic is configured to change the subsequent list entry value by determining a hash value, and replacing the subsequent list entry value with the hash value.

5. The system of claim 4, where the management logic is configured to:
determine the hash value over selected fields in the subsequent list entry; and
change the hash value if it is identical to the subsequent list entry value.

6. The system of claim 1, where the processing logic is configured to:
determine to process the subsequent list entry when the match exists between the next tracking value the subsequent tracking value.

7. The system of claim 1, where the processing logic is configured to:
determine to stop processing the linked list when the match does not exist between the next tracking value the subsequent tracking value.

8. The system of claim 2, where the management logic comprises a software linked-list manager.

9. The system of claim 1, where the processing logic comprises a hardware list processor.

10. The system of claim 1, where:
the processing logic comprises a hardware implemented list processor; and
the system further comprises a software linked-list manager that executes asynchronously with respect to the processing logic.

11. The system of claim 10, where the hardware implemented list processor comprises a hardware state machine.

12. The system of claim 1, where the processing logic comprises:
processing logic associated with an egress port in a switch device.

13. The system of claim 12, where the processing logic is configured to process the current list entry to replicate a packet for transmission out the egress port.

14. The system of claim 13, where the current list entry comprises a data element that specifies a packet processing action for the packet.

15. A system comprising:
a memory configured to store:
a linked list comprising a current list entry;
the current list entry comprising:
a current tracking field configured to store a current tracking value expected in the current list entry;
processing logic in communication with the memory, the processing logic configured to:
read and store the current tracking value as an original tracking value, when the processing logic first begins to process the current list entry;
suspend operation;
resume operation and re-read the current tracking field to obtain a current tracking value; and
determine whether to continue processing the linked-list depending on whether a match exists between the current tracking value and the original tracking value.

16. The system of claim 15, where the processing logic is configured to:
stop processing the linked-list when the match does not exist.

17. The system of claim 15, where the processing logic comprises:
processing logic associated with an egress port in a switch device.

18. The system of claim 17, where the processing logic is configured to process the current list entry to replicate a packet for transmission out the egress port.

19. The system of claim 18, where the current list entry comprises a data element that specifies a packet processing action for the processing logic to execute for the packet.

20. A system comprising:
a shared memory configured to store:
a linked list comprising a current list entry and a subsequent list entry;
the current list entry comprising:
a current tracking value;
a pointer to the subsequent list entry; and
a next tracking field configured to store a next tracking value expected in the subsequent list entry;
the subsequent list entry comprising:
a subsequent tracking field configured to store a subsequent tracking value for the subsequent list entry;
management logic in communication with the shared memory, the management logic configured to:
modify the subsequent tracking field the subsequent list entry, when the management logic determines to delete the subsequent list entry; and
processing logic in communication with the shared memory, the processing logic configured to:
before moving ahead to process the subsequent list entry, determine whether a match exists between the next tracking value the subsequent tracking value; and
forego processing the subsequent list entry when no match exists;
store the current tracking value in a context memory as an original tracking value for the current list entry; and
when resuming after suspension, obtain a re-read tracking value from the current list entry, and terminate processing of the linked list when the re-read tracking value does not match the original tracking value.
